(19) United States
(12) Patent Application Publication
(10) Pub. No.: US 2010/0042554 A1
(43) Pub. Date: Feb. 18, 2010

(54) MAILING SYSTEM HAVING EMPLOYEE PERSONAL POSTAGE ACCOUNTING CAPABILITY

(75) Inventors: Joan T. Doutney, Sandy Hook, CT (US); Sara M. Conklin, Oxford, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/193,250

(22) Filed: Aug. 18, 2008

(51) Int. Cl. G06Q 90/00

(52) U.S. Cl. 705/410

(57) ABSTRACT

A mail processing system that has employee personal postage accounting capability is provided. When a mail processing system is used to process personal mail, a record of the fees for such personal mail, associated with an identification of the employee sending the personal mail, is generated by the mail processing system. The mail processing system periodically sends such records to a payroll system, which uses the records to automatically deduct the fees from the respective employee's paycheck. By integrating the mail processing system to the payroll system, the mail processing system can be utilized by employees to process personal mail, and the fees for such personal mail collected from each employee, without the risk of handling cash in the mail room or the added expense of credit card fees.

### FIELD OF THE INVENTION

The invention disclosed herein relates generally to mailing systems, and more particularly to mail processing systems that have employee personal postage accounting capability.

### BACKGROUND OF THE INVENTION

Mail processing systems for preparing mail pieces, e.g., printing postage indicia on or for envelopes, parcels, flats, or any other item intended to be sent through the mail (hereafter collectively referred to as “mail piece”), have long been well known and have enjoyed considerable commercial success. There are many different types of mail processing systems, ranging from relatively small units that handle only one mail piece at a time, to large, multi-functional units that can process thousands of mail pieces per hour in a continuous stream operation. The larger mailing machines often include different modules that automate the processes of producing mail pieces, each of which performs a different task on the mail piece. The mail piece is conveyed downstream utilizing a transport mechanism, such as rollers or a belt, to each of the modules. Such modules could include, for example, a singulating module, i.e., separating a stack of mail pieces such that the mail pieces are conveyed one at a time along the transport path, a moistening/sealing module, i.e., wetting and closing the glued flap of an envelope, a weighing module, and a metering module, i.e., applying evidence of postage to the mail piece. The exact configuration of the mailing machine is, of course, particular to the needs of the user.

Typically, a control device, such as, for example, a microprocessor, performs user interface and controller functions for the mail processing system. Specifically, the control device provides all user interfaces, executes control of the mail processing system and print operations, calculates postage for debit based upon rate tables, provides the conduit for the Postal Security Device (PSD) to transfer postage indicia to the printer, operates with peripherals for accounting, printing and weighing, and conducts communications with a data center for postage funds refill, software download, rates download, and market-oriented data capture. The PSD contains one or more registers that store the accounting information concerning usage, such as, for example, an ascending register, descending register, piece count register, and the like. The control device, in conjunction with an embedded PSD, constitutes the system meter that satisfies U.S. information-based indicia postage meter requirements and other international postal regulations regarding closed system meters.

Mail processing systems such as described above are typically utilized in office environments, e.g., corporations, businesses, organizations, or any other type of entity that has multiple employees, to process the mail being sent for purposes related to the entity. The postage costs for such mail are paid for by the entity to which the system meter is leased. The descending register maintained within the PSD is typically refilled on a periodic basis, with the replenished funds being paid for by the entity.

As a convenience to employees, many such entities allow their employees to utilize the mail processing systems to process personal mail, provided that the employees pay for the postage for such personal mail. This convenience provides employees the ability to send mail without having to make a trip to the post office, and is generally a much utilized feature. However, this convenience for employees creates several problems for the entity, as it is necessary to collect funds from each employee based on the amount of postage used. This typically requires that each mailroom in which a mail processing system is located maintain a cash box such that cash can be collected by the mailroom personnel, and if necessary, change given, to employees that are processing personal mail. This requires that a supply of cash be available, which is not a very desirous situation. In addition, the mailroom personnel must maintain accurate records of the amount of postage expended for personal items, along with the amount of funds collected to ensure reconciliation. This adds significant amounts of paperwork and record keeping, which is also not a very desirous situation. If credit cards are utilized, the entity will be required to pay credit card processing fees for each transaction, or pass on such fees to the employees. This also is not a desirous situation.

Thus, there exists a need for a mail processing system that allows employees to process personal mail without the drawbacks associated with collecting funds for such personal mail from the employees.

### SUMMARY OF THE INVENTION

The present invention alleviates the problems associated with the prior art and provides a mail processing system that has employee personal postage accounting capability.

In accordance with embodiments of the present invention, when a mail processing system is used to process personal mail, a record of the fees for such personal mail, associated with an identification of the employee sending the personal mail, is generated by the mail processing system. The mail processing system periodically sends such records to a payroll system, which uses the records to automatically deduct the fees from the respective employee's paycheck. By integrating the mail processing system to the payroll system, the mail processing system can be utilized by employees to process personal mail, and the fees for such personal mail collected from each employee, without the risk of handling cash in the mail room or the added expense of credit card fees.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate a presently preferred embodiment of the invention, and together with the general description given above and the detailed description given below, serve to explain the principles of the invention. As shown throughout the drawings, like reference numerals designate like or corresponding parts.

FIG. 1 illustrates in block diagram form a system according to an embodiment of the present invention;

FIG. 2 illustrates in flow diagram form the processing performed according to an embodiment of the present invention.

### DETAILED DESCRIPTION OF THE INVENTION

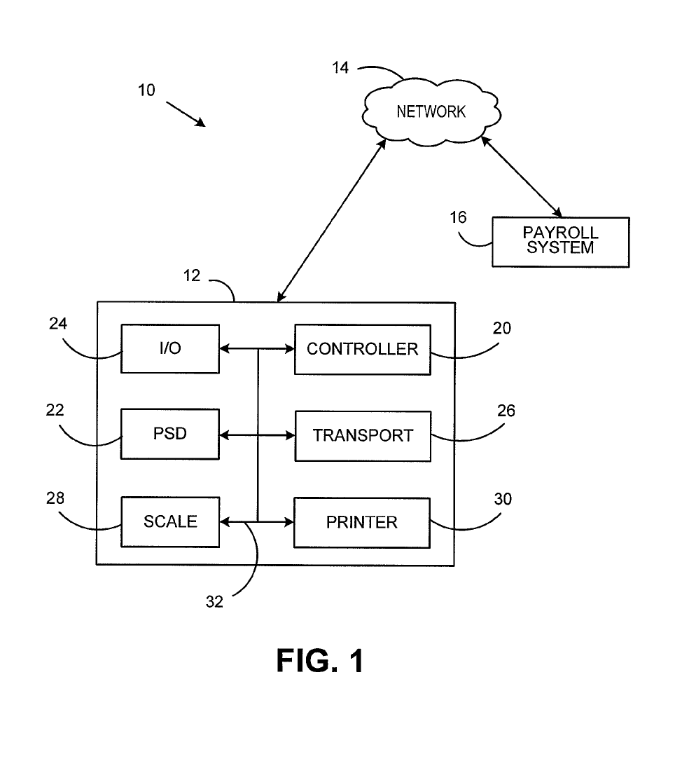

In describing the present invention, reference is made to the drawings, wherein there is seen in FIG. 1 a system 10 according to an embodiment of the present invention. System 10 includes a mailing machine 12 that is coupled to a network 14, such as, for example, a Local Area Network (LAN), Wide Area Network (WAN), or any other type of communication network. A payroll system 16 is also coupled to the network 14. Payroll system 16 generally includes one or more computer systems and databases (not shown) that utilize one or more accounting software programs to process payments, typically in the form of paychecks or pay stubs, to employees. The payroll system 16 maintains employee records, including personal information, employee identification numbers, and the like, for use in processing the payroll. Such payroll systems are generally well known in the art and need not be discussed further here for an understanding of the present invention.

The mailing machine 12 includes a control unit (controller) 20, that preferably includes one or more controller units, such as, for example, a microprocessor, general or special purpose processor or the like, to control operation of the mailing machine 12. Specifically, the controller 20, in conjunction with one or more other processors or controllers (not shown), provides all user interfaces, executes control of the mailing machine 12, calculates postage for debit based upon rate tables, provides the conduit for an associated Postal Security Device (PSD) 22 to transfer postage indicia for printing, operates with peripherals for accounting, printing and weighing, and conducts communications with a data center for postage funds refill, software download, rates download, and market-oriented data capture. The PSD 22 contains one or more registers that store the accounting information concerning usage, such as, for example, an ascending register, descending register, piece count register, and the like. The controller 20, in conjunction with the PSD 22, provides the system meter that satisfies U.S. and international postal regulations regarding closed system information-based indicia postage (IBIP) meters. While PSD 22 is shown as an external device to the controller 20 in FIG. 1, the PSD 22 may also be embedded within the controller 20.

The mailing machine 12 includes one or more input/output devices 24 such as, for example, a keyboard, a display device, touch screen, and/or a scanner. A mail piece transport mechanism 26 may be utilized to transport mail pieces through different modules of the mailing machine for processing of the mail piece. The transport mechanism 26 can include, for example, rollers or belts that are utilized to move a mail piece through various processing stations of the mailing machine 12. The mailing machine 12 can also include one or more scales 28 that can be used to weigh mail pieces being processed by the mailing machine 12. The scale 28 may be integral with the transport 26 such that letters can be weighed as they are being transported. The scale 28 may also include a platform scale that can be used to weigh mail pieces that are too large to be processed through the mailing machine 12 using the transport 26.

The mailing machine 12 further includes a printer 30, such as, for example, an ink-jet or thermal type printer that is utilized to print information on mail pieces being processed by the mailing machine 12. Such information could include, for example, an indicium that evidences payment of postage, address information, slogans and the like. Printer 30 is preferably adapted to print such information either directly on a mail piece, or alternatively on a tape that can be applied to a mail piece (for those mail pieces that are too large to be processed using the transport 26). Printer 30 could also be utilized to print receipts for processed mail or other types of reports associated with processed mail. Alternatively, printer 30 could comprise more than one printer. One or more communication buses 32 may be utilized to provide a communication path between each of the components of the mailing machine 12.

The system illustrated in FIG. 1 could be utilized in any entity that has multiple employees to process the mail being sent for purposes related to the entity. The postage costs for such mail are paid for by the entity responsible for the mailing machine 12. The descending register maintained within the PSD 22 is typically refilled on a periodic basis, with the replenished funds being paid for by the entity. The present invention allows the employees of the entity to process personal mail without the drawbacks associated with collecting funds for such personal mail from the employees as previously described.

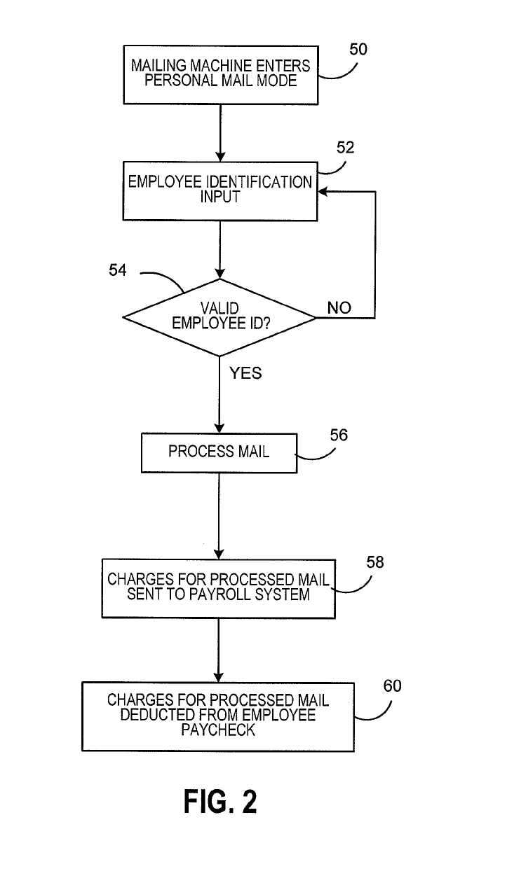

Referring now to FIG. 2, there is illustrated in flow diagram form the processing performed by an employee when processing personal mail using the mailing machine 12 and system 10 as illustrated in FIG. 1. In step 50, the mailing machine 12 is placed into a personal mail mode. This can be done, for example, by activating a key on the I/O device 24 (e.g., keyboard, touch screen, etc.). Once the personal mail mode has been entered, in step 52 the controller 20 will request, via the I/O 24, the input of an employee identification to which the charges for the processing of mail will be assessed. The user can then input an employee identification using, for example, the I/O device 24. Such input could be performed by scanning an employee identification number from an employee identification badge using the scanner, or by entering the employee identification number using the keyboard or touch screen.

Optionally, in step 54, the controller 20 will determine if the employee identification that has been input in step 52 is a valid employee identification. This can be performed, for example, by comparing the input identification to a list of authorized employee identification numbers maintained in a memory of the mailing machine 12 (provided as part of the controller 20). Checking the input identification number against a list of authorized identification numbers ensures that the mailing machine 12 is only being used by authorized employees and that the charges for processing personal mail can be validly assessed to an authorized employee. In step 54, if the employee identification that has been input is not a valid employee identification, then the processing will return to step 52 to request that a new employee identification be input. Optionally, as part of step 54, the controller 20 of the mailing machine can contact the payroll system 16 (or other system that maintains employee records) to check that the list of authorized employee identification numbers maintained in the memory of the mailing machine 12 is up-to-date, and therefore includes all new employees.

If in step 54, it is determined that the employee identification input in step 52 is a valid employee identification (or if step 54 is not performed), then in step 56 the mailing machine 12 can be utilized to process mail for the employee. Based on one or more inputs from the employee, using for example, the I/O 24 (e.g., keyboard or touch screen), the mailing machine 12 can process each mail piece that the employee desires to send. Such processing includes at least generating an indicium that evidences payment of postage, accounting for the postage costs, and printing the indicium. Processing can additionally include weighing the mail piece, requesting special services, e.g., tracking, insurance, or the like, printing additional labels, and/or printing a receipt for the amount of postage. If the mail pieces are letters, the letters can be simply run through the mailing machine 12 using the transport 26. If the mail pieces are too large to be processed through the mailing machine 12 using the transport 26, the mail pieces can be weighed using the platform scale 28, and a label printed by the printer 30 for application to the mail piece. As each mail piece is processed, the fees associated with delivery of each mail piece are determined by the controller 20 based on one or more of the weight, size, delivery service, special services, and the like for each mail piece. Alternatively, an indicium can be printed based on a postage amount requested by the employee. The amount of postage for each mail piece is indicated in the indicium generated by the PSD 22 in conjunction with the controller 20 that is either printed directly on the mail piece or on a label for application to the mail piece. The registers maintained in the PSD 22 are updated during processing of each mail piece to reflect the amount of funds being removed from the PSD 22. In addition, the controller 20 maintains a record of the costs for each mail piece being processed in association with the employee identification received in step 52.

Once the processing of mail has been completed in step 56, then in step 58 the controller 20 will send the record of the costs, along with the employee identification received in step 52, to the payroll system 16 via the network 14. Alternatively, instead of sending the record after completion of the processing of the mail in step 56, the controller 20 can aggregate records for a predetermined period of time and send multiple records on a periodic basis, such as, for example, at the end of each day, each week, or each pay cycle. In step 60, the payroll system 16, using the records received from the mailing machine 12, adjusts a subsequent paycheck of each of the employees that utilized the mailing machine 12 by deducting the amount of postage used by each employee for personal mail. Thus, if an employee utilized three dollars worth of postage during the previous pay cycle, the employee's paycheck will have a deduction in the amount of three dollars to pay for the personal postage. Since the funds used by each employee to process personal mail are deducted directly from the employee's paycheck, the employee does not need to provide cash when processing personal mail, or utilize a credit card, to pay for the postage. Thus, it is not necessary for the mail room to maintain a cash box, and significantly reduces the paperwork required to be maintained to reconcile the amount of postage used with the amount of cash collected.

In addition, the records generated by the mailing machine 12 during the processing of personal mail can be utilized to automatically replenish the descending register of the PSD 22. Thus, the mailing machine 12 can contact a remote data center automatically, via, for example, the network 14, and request a replenishment of funds equal to the amount to personal mail processed during the period. In this manner, the processing of personal mail, as seen by the entity responsible for the mailing machine 12, is a transparent transaction that does not require any additional record keeping or processing on the part of the entity. This will allow the mailing machine 12 to be able to be used by more entities to provide the employee benefit of mailing personal items directly from the office.

Thus, a mail processing system that has employee personal postage accounting capability is provided. By integrating the mail processing system to the payroll system, the mail processing system can be utilized by employees to process personal mail, and the fees for such personal mail automatically deducted from a paycheck of each employee, thereby removing the risk of handling cash in the mail room or the added expense of credit card fees. While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description.

What is claimed is:

1. A method for an employee of an entity to process a personal mail piece using a mailing machine associated with the entity, the method comprising:
receiving at the mailing machine an identification associated with the employee;
generating, using the mailing machine, an indicium to evidence payment of a cost for delivering the personal mail piece;
maintaining a record at the mailing machine including the cost for delivering the personal mail piece in association with the employee identification; and
sending the record from the mailing machine to a payroll system for use in deducting from a paycheck of the employee the cost for delivering the personal mail piece.

2. The method of claim 1, wherein receiving an identification further comprises:
determining if the received identification is a valid employee identification.

3. The method of claim 2, wherein determining if the received identification is a valid employee identification further comprises:
checking for an update to a list of authorized employee identification numbers.

4. The method of claim 1, wherein receiving an identification further comprises:
receiving an identification from a scanner used to scan an employee identification badge.

5. The method of claim 1, wherein receiving an identification further comprises:
receiving an identification from a keyboard used to type in the identification.

6. The method of claim 1, wherein generating an indicium includes weighing the mail piece.

7. The method of claim 1, wherein generating an indicium includes generating an indicium based on a postage amount requested by the employee.

8. The method of claim 1, further comprising:
printing a receipt for the cost for delivering the personal mail piece.

9. The method of claim 1, wherein sending the record from the mailing machine to the payroll system further comprises:
aggregating records for a predetermined period of time; and
sending the aggregated records from the mailing machine to the payroll system at the end of the predetermined period of time.

10. The method according to claim 1, further comprising:
using the record to automatically replenish a register of funds maintained in the mailing machine.
